(19) United States
(12) Patent Application Publication
(10) Pub. No.: US 2021/0058589 A1
(43) Pub. Date: Feb. 25, 2021

(54) Wearable Device for Enhanced Personal Safety

(71) Applicants: Robert L. Terry, Houston, TX (US); M. Harris Milam, Houston, TX (US); George W. Batten, JR., Houston, TX (US)

(72) Inventors: Robert L. Terry, Houston, TX (US); M. Harris Milam, Houston, TX (US); George W. Batten, JR., Houston, TX (US)

(21) Appl. No.: 16/550,217

(22) Filed: Aug. 24, 2019

(51) Int. Cl. H04N 7/18; H04M 1/725; H04N 5/225

(52) U.S. Cl. CPC H04N 7/185; H04M 2250/52; H04N 5/2253; H04M 1/72569

(57) ABSTRACT

This invention is a small, wearable module communicating with a smart phone; and smart phone software communicating with the module and remote web sites; the combination providing a visual indication that the environment around the person wearing the module is being recorded by a video camera and microphone, and remotely stored, so that there will be persistent, strong evidence of any harm to the person, thereby providing a basis for legal action.

### CROSS-REFERENCE TO RELATED APPLICATIONS

### U.S. Patent Documents

| | | | | |
|---|---|---|---|---|
| 9,325,824 | July 2015 | McLaughlin | Adjustable holder for portable | H04M 1/5041 |
| | | | device with sound enhancement | |
| 2016/0192164 | June 2016 | Scully | Wireless personal safety device | H04W 4/22 |
| 9,992,537 | March 2018 | Shah | Wearable-multisensory personal | G08B 25/016 |
| | | | safety and tracking device | |

### OTHER PUBLICATIONS

None

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISC APPENDIX

Not applicable

### STATEMENT REGARDING PRIOR DISCLOSURE BY THE INVENTOR

There have been no prior disclosures by the inventor.

### BACKGROUND OF THE INVENTION

The common use of video cameras in recording criminal activity is well known. This use has become even more widespread as cellar telephones, especially the so-called “smart phones,” with video capabilities have become ubiquitous.

Police have adopted cameras mounted in police vehicles and carried on their bodies (the so-called “body cams”) for their own protection and recording the behavior of suspects. Some of these camera systems stream video to secure central locations for storage, thereby providing some assurance that the images will not be altered or deleted.

Many people believe that persons who know their actions are being video recorded behave better. As this belief is especially strong for confrontational encounters between police and citizens, many people want their cell phones to provide remotely-stored video recording and an indication that the recording is active. Some companies already provide remotely-stored video recording for cell phones, but handling the cell phone and providing the indication can be difficult.

The present invention simplifies such use by providing a hands-free, non-confrontational deterrent to physical and verbal abuse. It is designed to deter, rather than defend.

### The Prior Art

Patent application US 2016/0192164 A1 has an extensive discussion of personal safety issues and devices intended to increase personal security, but nothing about police-citizen confrontation. U.S. Pat. No. 9,325,824 teaches a wearable holder for a smart phone, the primary purpose of which is simplification of smart phone use while driving a vehicle. U.S. Pat. No. 9,325,824 teaches a wearable with many sensors, and facility for sensing and reporting problem conditions, but it deals with problems after they have occurred, so it is not directed to deterrence.

### BRIEF SUMMARY OF THE INVENTION

This invention comprises a clothing-mountable module linked to a smart phone with a related application software element (hereinafter, often called “app”). The exact type of linkage is unimportant, but the link must be bidirectional and sufficiently fast; wireless—e.g., Bluetooth, Wifi, or near-field communication (NFC)—is preferred.

In one preferred arrangement, the module contains a microcontroller controlling a video camera with a microphone, an indicator light-emitting diode (LED) controlled by the microcontroller, one-or-more user-operated buttons, and a power source (e.g., a battery). A speaker can be included to provide an audible indication.

In a typical application, when the user expects to be in an environment having persons who may be threating, the user would put the module on the front of his or her clothing with the camera facing forward, and activate the smart-phone app. Then, if a potentially threating person approaches, the user can press a button on the module, thereby causing
1. the indicator LED to start flashing,
2. the video camera and microphone to start capturing images and audio,
3. the microcontroller to deliver the acquired video data to the smart phone, and
4. the already-operating smart-phone app to transmit the data to a secure remote location (or, if the remote location is not accessible, to store the data for transmission and/or review later). The secure location could be an Internet Cloud.
   The flashing light notifies nearby persons that their actions are being recorded. As is noted above, this notification is likely to encourage better behavior of those persons.

As a particular example, a woman who is about to run in a park where she might encounter unfriendly persons could put on the module and turn on the flashing LED, thereby providing an early deterrent to would-be attackers.

### BRIEF DESCRIPTION OF THE SEVERAL VIEWS OF THE DRAWINGS

FIG. 1 schematically shows the front view of the module. This has an indication of internal features of components that have access to the exterior of the module's case, but no other internal components.

FIG. 2 schematically shows a side view of the module with some hidden internal components.

FIG. 3 is a flow chart for the module firmware. This diagram uses the following abbreviations:
FBP for Flash Button Pressed;
OS for On Stop.
RBP for Record Button Pressed;
S for Start.

FIG. 4 is a flow chart for the smart-phone software. This diagram uses the following abbreviations:
FBP for Flash Button Pressed;
OS for On Stop.
RA for Remote Available.
RNA for Remote Not Available.
RBP for Record Button Pressed;
UA for User Activation.
UT for User Termination.

### DETAILED DESCRIPTION OF THE INVENTION

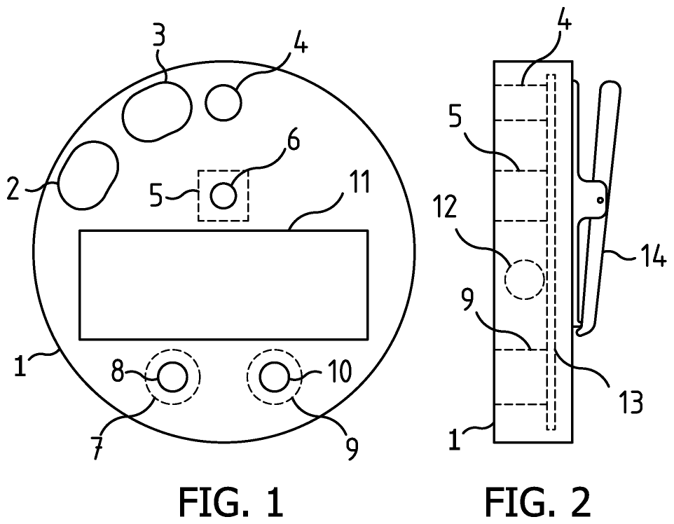

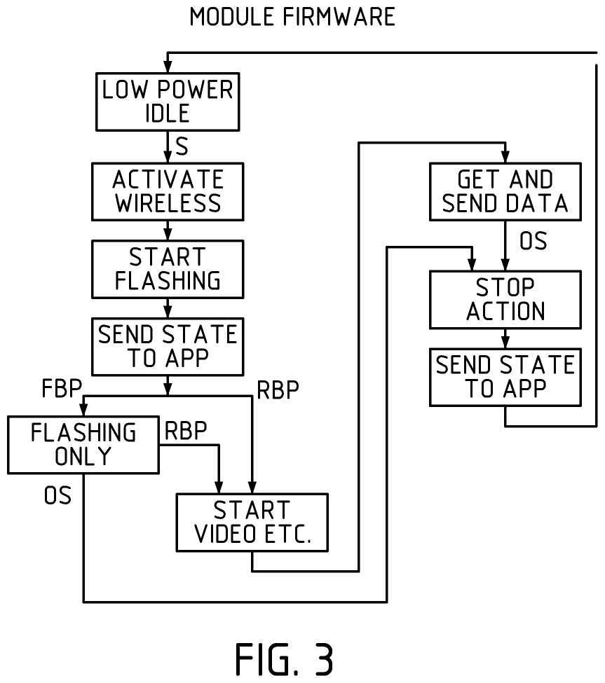

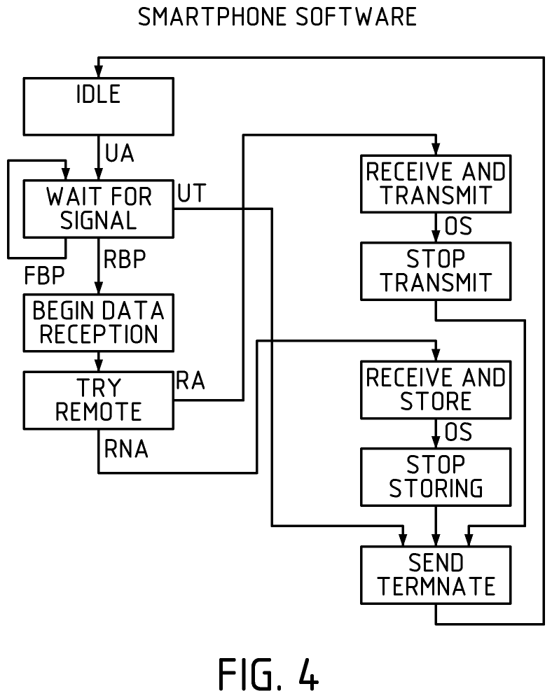

Refer to FIG. 1 and FIG. 2. The following description is for one preferred embodiment of the invention.

The case 1 has a spring clip 14 for attaching the module to clothing. The figures do not show the thickness of the wall of the case.

On the front there are two buttons 2 and 3. One of these, called the “flash button” (e.g., 2), is used to start flashing LED 4 with no other action, with a second press of the button stopping the flashing. The other button, called the “record button” (e.g., 3), starts the full operation: LED flashing; video and audio capture and transmission (or storage) and audible indication if that is available and enabled; with a second press of the button stopping all of that action.

The lens of video camera 5 has optical access to the scene through viewport 6. Microphone 7 and speaker 9 have acoustic access through ports 8 and 10, respectively.

A label, indicated by label rectangle 11, identifies the module and provides a visual indication that recording of activities is possible.

Internal components, including the single-chip with wireless transceiver and associated antenna, are mounted on printed circuit board 13. The module is powered by battery 12, which can be a single-use battery (e.g., a coin cell, which would have a different physical arrangement than that indicated by 12), or a rechargeable battery with a charging facility (not shown).

Actions controlled by the firmware in the module's are linked to actions controlled by the software (app) in the smart phone. FIG. 3 is a flowchart for a preferred embodiment of the module firmware, and FIG. 4 is a flowchart for a preferred embodiment of the smart phone software.

As shown in FIG. 3, when the module is inactive it is in a low-power mode, indicated by the LOW POWER IDLE box. The user activates the module by a flash-button press (FBP) a record-button press (RBP), or an app-related button on the smart phone (the latter requiring that the wireless connection be at least partially activated). Collectively, these are indicated as a start signal (S). In any case, the module's microcontroller comes out of the low-power mode; it activates the full wireless connection to the smart phone (ACTIVATE WIRELESS), starts flashing the LED (START FLASHING), and sends an indication of the module state to the smart phone (SEND STATE TO APP).

The smart phone can have app-related buttons corresponding to the flash button and the record button, in which case those cause the same actions as the corresponding buttons on the module. Otherwise, a single app-related button will cause the same action as the record button.

Next, the module firmware branches depending on which button has been pressed. For the flash-button press (FBP) the firmware starts flashing the LED (FLASHING ONLY). This is terminated by either an on-stop signal (OS) which is either a button press or a corresponding signal from the smart phone. For a flash-button press or a stop signal from the smart phone, the action (flashing) is stopped (STOP ACTION), an indication of the module state is sent to the smart phone (SEND STATE TO APP), and the module enters the idle state (LOW POWER IDLE). For a record-button press (RBP), the firmware begins recording (START VIDEO ETC.).

If the record-button was pressed (RBP) when the module was in the low-power idle state, the module starts acquiring video and other data (e.g., sound via the microphone) (START VIDEO ETC.) and sending it to the smart phone (GET AND SEND DATA). This action is stopped (STOP ACTION) by the press of any button or a corresponding smart phone signal (OS). Then, an indication of the module state is sent to the smart phone (SEND STATE TO APP), and the module enters the idle state (LOW POWER IDLE).

As shown in FIG. 4, the smart phone software (app) is inactive (IDLE) until the user activates it (UA). Then the app waits for a signal from the module or user action (WAIT FOR SIGNAL). If the user terminates the operation (UT), the app sends a termination signal to the module (SEND TERMINATE), then returns to the inactive state (IDLE).

If the signal was from a flash-button press (FBP), the smart phone has nothing to do, so it continues to wait for a signal (WAIT FOR SIGNAL).

If the signal is from a record-button press (RBP), the smart phone must receive data from the module, and either send it to a remote location or store it, so it begins reception of data (BEGIN DATA RECEPTION), and tries to link to a remote World Wide Web (WWW) location (TRY REMOTE). If it identifies an available location (RA) it begins receiving and transmitting data (RECEIVE AND TRANSMIT). If it cannot establish such a link (RNA) it begins receiving and storing data (RECEIVE AND STORE). Note that the expression “remote location” includes facilities in the so-called Internet cloud.

In either case, the app continues the action until it receives an on-stop signal (OS), which is any button press, user termination, or error condition (i.e., data overflow, loss of link, et.). Then the app stops transmitting data to the remote site (STOP TRANSMIT), or stops storing data (STOP STORING), and sends a termination signal to the module (SEND TERMINATE), then it returns to the inactive state (IDLE).

Persons knowledgeable of the relevant art will recognize the following:
If the battery is rechargeable, a charging connection (not shown) will be needed. Also, there must be an indication when the battery needs charging. This can be an additional LED in the module or an indicator icon on the smart-phone display.
If the link to a remote location fails while the smart phone software is receiving and sending data, the software should begin storing the data locally, and attempt reestablishing the link. Data stored locally should be preserved after the software becomes inactive (IDLE).
If the battery is rechargeable, a connector for charging must be included. Such a connector is not shown in the figures.
The invention remains useful if the flash-only provision is eliminated. This entails elimination of the button (e.g., 2) and corresponding items in the flow charts (FIG. 3 and FIG. 4).
The speaker is not required for the invention, but if it is included it can provide an audible indication similar to that of the LED. Modification of firmware (and possibly the smart phone software) would be necessary, of course.
A module without video camera, microphone, etc., but only a switch turning on a flashing light would be useful for indicating that a smart phone is recording the scene using its own camera and microphone.
In some applications it might be desirable to record without having the LED flashing. The smart-phone app can have a feature allowing the user to separate the flashing and recording functions of the buttons.
Since dark places (e.g., at night) are important environments for using the invention, a light source is useful. Microcontroller-managed LEDs providing infrared light are a preferred light source.
In one preferred application, the module is placed on the vanity mirror of an automobile for protection of the vehicle and its occupants, and an information sticker showing that the vehicle has an active module is placed on the rear of the vehicle, to provide deterrence to physical and verbal abuse. The sticker could have a highly reflective red dot to call attention to use of the system in the vehicle.
The module can be equipped with a strap instead of a spring hook, thereby allowing, for example, a user to wear it on a wrist. Also, the strap would be useful for mounting the module in an automobile.

1. A system comprising a module and a smart phone app (software), said app installed in a smart phone associated with said system;
said module having a case with a means by which it can be attached to a user's clothing or body, said means hereinafter called “fastener,” a firmware-controlled microcontroller with wireless capability, a video camera controlled by the microcontroller, switches linked to the microcontroller, a light-emitting diode (LED) controlled by the microcontroller, and a battery, all mounted in the case;
the said video camera and light-emitting diode exposed through ports in the side of the case opposite to that with the fastener;
the said microcontroller wirelessly linked to said smart phone;
the said switches mounted for manipulation from the exterior of the case;
one of said switches starting only flashing of the LED, or stopping all action already ongoing;
one of said switches starting full action of the system, including flashing of the LED, acquisition of data including images from the video camera, transmitting data from the module to a smart phone, and starting related actions withing the smart phone; or stopping all action already ongoing;
said smart phone app, when activated, causing the smart phone to receive data transmitted from the module, and either transmit the data received to a remote site or store the data locally within the smart phone.

2. A system as in claim 1 the module for which also has a microphone delivering sound data to the microcontroller for transmission to the smart phone.

3. A system as in claim 1 the module of which also has a microcontroller-controlled speaker.

4. A system as in claim 1 but comprising only the module, said module having neither the wireless capability nor the video camera.

5. A system as in claim 1 for which the fastener is a spring hook.

6. A system as in claim 1 for which the fastener is a wrist strap.
